(19) United States
(12) Patent Application Publication
(10) Pub. No.: US 2014/0279044 A1
(43) Pub. Date: Sep. 18, 2014

(54) SYSTEM AND METHOD FOR OMNI-CHANNEL IDENTITY MATCHING

(71) Applicants: Joshua Summers, Lexington, MA (US); Victor Mendoza, Revere, MA (US)

(72) Inventors: Joshua Summers, Lexington, MA (US); Victor Mendoza, Revere, MA (US)

(73) Assignee: eBay Inc., San Jose, CA (US)

(21) Appl. No.: 13/929,897

(22) Filed: Jun. 28, 2013

Related U.S. Application Data
(60) Provisional application No. 61/792,305, filed on Mar. 15, 2013.

(51) Int. Cl. H04L 29/08

(52) U.S. Cl. CPC H04L 67/306
USPC 705/14.66; 709/217

(57) ABSTRACT

In various example embodiments, a system and method for omni-channel identity matching is provided. In example embodiments, identifiers from online and offline communication channels are obtained. A user that corresponds to at least one of the identifiers is identified. An identity profile is created for the user that contains the at least one of the identifiers corresponding to the user. The identity profile is maintained in an identity profile store. A communication, such as an ad request, containing an identifier is received. The identity profile that matches the identifier received in the communication is determined. In some embodiments, an advertisement may be determined to be returned to the user based on the identity of the user.

### CROSS-REFERENCE TO RELATED APPLICATION

This application is a Non-Provisional of and claims the priority benefit under 35 U.S.C. 119(e) of U.S. Provisional Application No. 61/792,305 filed on Mar. 15, 2013 and entitled “System and Method for Omni-Channel Identity Matching.”

### FIELD

The present disclosure relates generally to information exchange and, in a specific example embodiment, to identity matching and ad provisioning across different communication channels.

### BACKGROUND

Traditionally, it is difficult to identify a user over disparate communications channels. For example, it is difficult to determine that a person on a mobile device is the same person that is online. Prior art algorithms typically provide guesses as to the identity of users. That is, prior art algorithms reduce the identity down to a few likely candidates that may be the same, but do not provide a one-to-one solution.

### BRIEF DESCRIPTION OF DRAWINGS

Various ones of the appended drawings merely illustrate example embodiments of the present invention and cannot be considered as limiting its scope.

FIG. 1 is a diagram illustrating an example environment in which embodiments of a system for omni-channel identity matching may be implemented.

FIG. 2 is a block diagram illustrating an example embodiment of an omni-channel management system.

FIG. 3 is an illustration of identity synchronization for a user according to an example embodiment.

FIG. 4 is a flow diagram of an example high-level method for providing identity matching and ad provisioning.

FIG. 5A-5D are flow diagrams of example methods for identity matching.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for identity matching and advertisement provisioning across different communication channels. In example embodiments, identifiers from online and offline communication channels are obtained. A user that corresponds to at least one of the identifiers is identified. An identity profile is created for the user that contains at least one of the identifiers corresponding to the user. The identity profile is maintained in an identity profile store. A communication, such as an ad request, containing an identifier is received. The identity profile that matches the identifier received in the communication is determined. In some embodiments, an advertisement may be selected to be returned to the user based on the identity of the user.

In example embodiments, identity information from an omni-channel management system is matched to identity information from another entity (e.g., publisher, carrier, third party). A request for information, such as a request for an advertisement, may then be augmented with a corresponding identifier that explicitly identifies a user associated with the request. The identity of the user is then used to provide a targeted advertisement. In some embodiments, the identity information may be hashed versions of identity information. This is to ensure there is no transmission of personally identifiable information (PII). The matching may be performed at the omni-channel management system, at the carrier, or at the third party.

By using embodiments of the present invention, a user may be easily identified by a network-based system regardless of the communication channel the user is using. The user does not need to individually login in on each device or each communication channel in order to identify themselves. Accordingly, one or more of the methodologies discussed herein may obviate a need for the user to individually login in order to be identified by the network based system. Additionally, the system can accurately determine the identity of the user regardless of the communication channel the user is using. Thus, a technical effect of reducing computing resources used by one or more devices within the system may be achieved. Examples of such computing resources include, without limitation, processor cycles, network traffic, memory usage, storage space, and power consumption.

With reference to FIG. 1, a diagram illustrating an example environment 100 in which embodiments of a system for omni-channel identity matching may be implemented is shown. The environment 100 comprises an omni-channel management system 102 coupled via one or more networks 104 (e.g., the Internet, wireless network, cellular network, or a Wide Area Network (WAN)) to a user device 106 associated with a user. The user device 106 may comprise a mobile phone, laptop, tablet, or any other communication device (e.g., mobile device) that a user may utilize to communicate and exchange data via the network 104. While only one user device 106 is shown in FIG. 1, it is noted that any number of user devices 106 of different users may be present in the environment 100.

The omni-channel management system 102 manages identity matching across different communication channels. Based on the identity of the user, the omni-channel management system 102 may provide targeted advertisements to the identified user. To enable these operations, the omni-channel management system 102 may be communicatively coupled to a publisher system 108, a third party data provider 112, and a carrier or ISP 114. The omni-channel management system 102 will be discussed in further detail in connection with FIG. 2.

The publisher system 108 represents a publisher (e.g., Pandora, AccuWeather, Fox News) that agrees to participate with the omni-channel management system 102. When the publisher system 108 sends the omni-channel management system 102 an ad request, the publisher system 108 may include an identifier that the omni-channel management system 102 may effectively match to an identifier known to the omni-channel management system 102. This can either be a publisher specific identifier or an omni-channel management system 102 identifier that has been synced with the publisher system 108. This allows the omni-channel management system 102 to match identifiers that the omni-channel management system 102 cannot identify that come from, for example, a carrier stack. Additionally, the publisher system 108 may pass a universal identifier that can be used by the omni-channel management system 102 to bridge over to an identifiable and known identifier.

The third party data provider 112 is an intermediary that can perform an identifier exchange (or match) without either party (e.g., the omni-channel management system 102 and the publisher system 108) having to share any information that may be, for example, confidential or proprietary. In some embodiments, the third party data provider 112 may append a third party identifier to the communications in order for the parties to identify the user.

The carrier 114 may comprise a service provider (e.g., Verizon) or an ISP (e.g. Comcast). The carrier 114 may manage a gateway through which communications may pass. For example, the publisher system 108 may send a request that passes through the gateway of the carrier 114. The carrier 114 may then append an identifier (e.g., a carrier-associated identifier) that can be used by the omni-channel management system 102 to identify the user. In example embodiments, the identifier is specific to the relationship between the carrier 114 and the omni-channel management system 102 and passed in the header of the device request so as to not be identifiable by any other party.

In some embodiments, the carrier 114 may perform the matching of the identifiers. For example, the omni-channel management system 102 may append an internal identifier (e.g., PayPal identifier) to ad requests. Because the carrier 114 sees all the HTTP (HyperText Transfer Protocol) traffic that goes through their network, the carrier 114 may take a URL (Uniform Resource Locator) when it comes through their network, and the carrier 114 may match that URL to the customer (e.g., user) that they are delivering the URL to. For instance, a request may come in with a PayPal identifier of 12345. The request may be received from user 68495 by the Verizon carrier. In response, the omni-channel management system 102 may ship back an identifier match that allows the carrier 114 to determine who that customer is. This embodiment requires that the omni-channel management system 102 send customer files containing, for example, the internal identifiers (e.g. PayPal identifier) offline and ahead of time to the carrier 114, so that the carrier 114 may effectively drop back a known identifier on an unknown request.

As such, the role of the carriers 114 includes an ability to take an unidentified consumer and perform a match against an offline set of data that the omni-channel management system 102 has supplied to the carrier 114 and provide back an identifier (e.g., an internal identifier or a master identifier) to the omni-channel management system 102 in an ad request before the ad request reaches an ad server of the omni-channel management system 102. Consequently, the carrier gateway becomes a match provider for the omni-channel management system 102 by intercepting the ad request between the user device 106 and server(s) associated with the omni-channel management system 102. While the carrier 114 is performing the match in this embodiment, the omni-channel management system 102 provides the ability for the carriers 114 to be able to perform the match by giving the carrier 114 the data match file and a process for appending the omni-channel management system 102 identifier into a URL for the omni-channel management system 102. This process to append may comprise a model that indicates that when the carrier 114 detects a particular identifier, the carrier 114 adds an identifier string to the URL of the omni-channel management system 102. This identifier string is recognizable by the omni-channel management system 102 to identify the user.

However, the carriers 114 may not provide all of the information that the omni-channel management system 102 needs to create an entire profile for a user. For example, Verizon may detect identifiers and perform matches when the communication goes through its cellular gateway. However, if the user is not using a Verizon cellular connection or is not a customer of a participating carrier 114, the omni-channel management system 102 cannot obtain the matching information. As such, a bridge may be built to a match by using publishers and their information (via the publisher system 108).

In example embodiments, the publishers use unique identifiers that are more universal, such as an Open Device Identification Number (ODIN), which is an industry standard identifier that may be generated on the user device 106 by the publisher. The ODIN may be the same no matter which publisher generates the unique identifiers. In one example scenario, Pandora may send an ODIN plus a Pandora identifier along with an internal (omni-channel management system 102) identifier (e.g., a PayPal identifier if the omni-channel management system 102 is associated with PayPal) if the internal identifier has been previously matched with Pandora. However, assuming, for example, a previous match was not made with Accuweather, Accuweather may send an Accuweather identifier plus the ODIN. The omni-channel management system 102 may then be able to bridge a profile of the omni-channel management system 102 to Pandora through to Accuweather because Accuweather and Pandora both have the same ODIN while Pandora and PayPal both have the same ODIN, the Pandora identifier, and PayPal identifier. This process is referred to as bridging through other providers, and can be replicated across many bridges (not just between two companies).

It is noted that the environment 100 shown in FIG. 1 is exemplary. For example, alternative embodiments may comprise any number of publisher systems 108, third party data providers 112, and carriers 114 in the environment 100. Beyond mobile, communication traffic may flow through standard cable operators and broadband. Thus, further embodiments may include entities, for example, like Comcast and Time Warner. These entities are contemplated, but not shown in the embodiment of FIG. 1.

Referring now to FIG. 2, a detailed block diagram of the omni-channel management system 102 is shown. The omni-channel management system 102 may manage or enable identity matching and ad provisioning. To enable these operations, the omni-channel management system 102 comprises an ad server 202, a campaign manager 204, a RPS manager 206, an identity profile store 208, and a user profile store 210.

In example embodiments, the ad server 202 receives a request from the publisher system 108 and processes the URL in the request. The ad server 202 may determine which advertisement to return in response to the request, and return the appropriate advertisement. The determination of the advertisement may be based on the identity of the user from which the ad request is received. The identity may be determined based on the identity matching operations as discussed herein. In an alternative embodiment, the real-time profile store (RPS) manager 206 may perform the determination of the advertisement to return.

The campaign manager 204 allows the omni-channel management system 102 to market against all the profiles stored in the omni-channel management system 102 (e.g., in the user profile store 210). The campaign manager 204 is where campaigns may be launched against the ad server 202. The campaign manager 204 may notify the ad server 202 as to which of the hosted advertisements or content should be pushed back to the user (e.g., push out the URL to access that content). In example embodiments, the campaign manager 204 does not know the identities of the targeted customers, just the segments that they represent to ensure proper PII.

In example embodiments, the RPS manager 206 manages the identities and identity profiles. Accordingly, the RPS manager 206 may obtain identifiers from online and offline communication channels (e.g., by exchanging identifiers or receiving directly from the user) and identify a user that corresponds to these identifiers. The RPS manager 206 may then create an identity profile for the user. The identity profile contains all of these known identifiers corresponding to the user. The identity profile is then maintained in the identity profile store 208 of a management system.

The identity profile store 208 stores the user identifiers associated with the users. The identity profile store 208 may be accessed by the ad server 202, via the RPS manager 206 to look up profiles of identifiers. Once a profile identity is determined (e.g., a matching identifier is determined), the ad server 202 may, via the RPS manager 206, look up data in the user profile store 210 and use the data to decide which advertisement to present to the user.

The user profile store 210 stores underlying profile information for all the users of the omni-channel management system 102. For example, a user profile may contain consumer information (e.g., from eBay) such as preferences and past transaction history. At ad request time, a lookup may be performed against the user profile store 210 to obtain information on the user and determine a highly relevant ad placement for the user.

In example embodiments, the user profiles are stored separately from the identity data because these data change at different rates. Identities for matched identifiers tend to stay static, but data on consumers (e.g., user profile data) may change more frequently. However, alternative embodiments may combine the identity profile store 208 and the user profile store 210.

In example embodiments, an advertisement may be determined by a cookie. For example, a request from a device may arrive at the ad server 202. The ad server 202 and/or the campaign manager 204 respond with a campaign to run. The campaign may be determined based on a first party tracking initiative (FPTI). This FPTI may be a cookie that is internal to the omni-channel management system 102 that may be used to determine the identity of the user associated with the device by comparing the FPTI against identity profiles in the identity profile store 208. The cookie may synch back to the ad server 202 in order to determine which campaign and, thus, advertisement to provide to the device.

In another embodiment, the ad server 202 may receive an ad request with a URL. That URL (e.g., including an identifier embedded by the carrier 114) creates a lookup against the identity profile store 208. The identity profile store 208 returns an identity profile back to the ad server 202. The user profile store 210 may be accessed to obtain a corresponding user profile to the returned identity profile. The campaign manager 204 may then be accessed to determine which campaign to run for the identified user based on the corresponding user profile. The targeted advertisement associated with the campaign may then be delivered by the ad server 202.

FIG. 3 is an illustration of identity synchronization for a user according to an example embodiment. The various identifiers for the user may be stored in an identity profile (e.g., stored in the identity profile store 208) for use in matching and identifying the user across different communication channels by the omni-channel management system 102. The identifiers may include personally identifiable information (PII). Standard PIIs include, for example, email address, home address, and phone or mobile number. In some embodiments, these standard PII may be hashed versions stored in a database, such as a hash version generated using the Secure Hash Algorithm 1 (SHA-1 or sha1) algorithm. Mobile specific PIIs may include an ODIN and a publisher hashed version of an identifier. The omni-channel management system 102 may also store and use third party, social platform identifiers (e.g., Facebook identifiers, LinkedIn identifiers), and a media network identifier. While single versions of example PIIs are shown in FIG. 3, it is noted that any number of the same type of PIIs may be associated with a user in the identity profile. For example, more than one email address may be stored in the identity profile for the user.

Additionally, identifiers that are internal to the omni-channel management system 102 may be accessed for matching with other identifiers. These internal identifiers may be used, for example, for logging in and performing operations with respect to systems associated with the omni-channel management system 102. For example, the omni-channel management system 102 may be associated with eBay and PayPal and the internal identifiers may include an eBay identifier and a PayPal identifier.

In example embodiments, a master user identifier may be created for, and associated with, the user. This master user identifier corresponds to all of the various stored identifiers and may be used to query, for example, the ad server 202 for a targeted advertisement for the identified users. As such, all identifiers associated with different communication channels may be tied back to the master identifier as well as corresponding to each other in the identity profile.

FIG. 4 is a flow diagram of an example high-level method for providing identity matching and advertisement provisioning. In operation 402, identifiers are obtained. In example embodiments, various identifiers are obtained for a particular user. These identifiers may include personally identifiable information (PII) such as email addresses, home addresses, and phone numbers. The identifiers may also include internal omni-channel management system 102 identifiers as well as third party identifiers, social platform identifiers, and media network identifiers. In some embodiments, the identifiers may be obtained by exchanging identifier information with, for example, carriers. The identifiers may also be obtained directly from the users, themselves (e.g., via the user creating accounts with systems associated with the omni-channel management system 102, such as eBay or PayPal in the present example).

These identifiers are linked in operation 404. For example, attributes for the user may be queried from every data source of each identifier in order to determine an identity from any single identifier. Furthermore, a master identifier may be created that corresponds to all of the identifiers identified for the particular user.

In operation 406, an ad request is received. The ad request may include a particular identifier that is associated with the user. The identifier may be provided by the publisher or the carrier 114. Using the identifier associated with the user found in the ad request, the omni-channel management system 102 determines the user associated with the identifier in operation 408. Various methods for determining the user are discussed in FIG. 5a-5d. The omni-channel management system 102 may, in some embodiments, also determine a particular advertisement to be returned to the user in operation 410.

In one example, the user may be presented an untargeted banner on a webpage provided by a publisher. The publisher sends the omni-channel management system 102 a request to send them back an advertisement. The request comes through a carrier gateway (e.g., Verizon's gateway for HTTP traffic). The carrier 114 or service provider appends a matched identifier when it comes through the carrier gateway. The matched identifier is an identifier that the omni-channel management system 102 has knowledge of (e.g., found in an identity profile stored in the identity profile store 208). The carrier 114 has that matched identifier because offline a match key exchange was performed between the omni-channel management system 102 and the carrier 114. The request is received by the omni-channel management system 102 (e.g., the PayPal media network). A look up is performed in the identity profile store 208, and the user is identified. Additionally, the user's profile may be accessed from the user profile store 210 to determine attributes of the user which are used to identify a target advertisement to display to the identified user.

In another example, a publisher sends an ad request with a hashed version of an identifier (e.g., sha1=def456) to the omni-channel management system 102 (e.g., the PayPal media network server). The omni-channel management system 102 queries the identity profile store 208 to look up that identifier. The omni-channel management system 102 may send details of the identifier to the ad server 202 so that the ad server 202 includes the appropriate advertisement in response to the ad request.

Thus, example embodiments allow the omni-channel management system 102 to layer all the data from the carrier matches with all the data from the publisher matches resulting in a massive dataset of matched identifiers, with all of these variable identifiers matching back to a single identity profile in the identity profile store 208. Using the single identity profile, the user may be identified and targeted advertisement may be presented to the user.

FIG. 5A is a flow diagram of an example method 500 for identity matching. In the present embodiment, a direct publisher match is performed. In operation 502, an exchange of identifiers is performed. In some embodiments, an offline match key exchange may be performed between the publisher and the omni-channel management system 102. Thus, the identity profiles may be exchanged directly between the publisher and the omni-channel management system 102 without any intermediary being involved. For example, the publishers may provide publisher identifiers, such as standard API (Application Programming Interface) models (e.g., ODIN or UDID (Unique Device ID)), while the omni-channel management system 102 provides a master user identifier or internal identifier (e.g., eBay user identifier). In other cases, the omni-channel management system 102 provides an identifier based on a match operation. In these cases, the publisher may send a customer file and the omni-channel management system 102 sends back an omni-channel management system 102 identifier that the publisher can use to send back in the ad request.

In operation 504, an ad request is received from the publisher. In some cases, the ad request includes a known identifier. The known identifier is an identifier that the omni-channel management system 102 has in an identity profile in the identity profile store 208. In example embodiments, the identifiers have been previously exchanged, and the publisher has knowledge of the identifiers in the identity profile at the omni-channel management system 102. Thus, the publisher can simply send an ad request that contains the known identifier.

In operation 506, the omni-channel management system 102 matches the known identifier in the ad request to an identifier in the identity profile store 208. For example, if the publisher is Pandora, Pandora may pass a hashed version of their identifier to the omni-channel management system 102. The omni-channel management system 102 attempts to match the Pandora identifier to a hashed version in omni-channel management system 102 (e.g., hashed e-mail address). If there is a match, then the user is identified.

FIG. 5B is a flow diagram of an alternative example method 510 for identity matching. In this embodiment, personally identifying information (PII) is not directly exchanged. There may be cases where the PII is not exchanged because of privacy rules. Instead, non-PII information that corresponds to an identifier may be exchanged. This non-PII information may be matched with a piece of PII (e.g., home address) at the omni-channel management system 102 and sent to a third party in operation 512. The third party also receives a similar file from the publisher in operation 514. The third party then performs a match using the non-PIIs in operation 516. In some cases, the third party may create a third party identifier that maps back to a publisher non-PII and an omni-channel management system 102 non-PII in operation 518. The third party identifier may then be provided to the publisher and the omni-channel management system 102 in operation 520.

To illustrate, assume the publisher is Pandora. The third party receives a Pandora identifier and an identifier associated with the omni-channel management system 102 (e.g., PayPal identifier) that both match to, for example, the same home address. The third party defines a new identifier (e.g., third party identifier) that maps back to both the Pandora identifier and the PayPal identifier. The third party identifier is then provided back to PayPal with the PayPal identifier and provided back to Pandora along with the Pandora identifier. As a result, PayPal and Pandora may communicate using the third party identifier.

In example embodiments, the third party identifier is stored to the identity profile in the identity profile store 208 for the corresponding user. The omni-channel management system 102 may access the identity profile store 208 using any piece of PII which maps to the third party identifier (which may also map to a universal omni-channel management system 102 identifier).

Referring now to FIG. 5C, a flow diagram of another example method 530 for identity matching is provided. The method 530 provides for a carrier match. In example embodiments, the omni-channel management system 102 sends customer files containing, for example, the internal identifiers (e.g. PayPal identifier) offline and ahead of time to the carrier in operation 532.

In operation 534, an ad request is received from the carrier. In example cases, the ad request includes an identifier (e.g., a hashed identifier) to a URL that is known to the omni-channel management system 102 based on the exchange in operation 532. Thus, the identifier is an identifier that the omni-channel management system 102 maintains in the identity profile for the user. For example, when the carrier 114 detects a particular identifier of the user, the carrier 114 adds an identifier string to the URL of the omni-channel management system 102 that is recognizable by the omni-channel management system 102. Thus in operation 536, the omni-channel management system 102 determines the identity of the user based on the identifier string that was added by the carrier.

Referring now to FIG. 5D, a flow diagram of a further example method 540 for identity matching is provided. In this embodiment, a “bridge” is created at the omni-channel management system 102 to determine the identity of the user. In operation 542, a first publisher provides a PII (e.g., e-mail address) and an ODIN in a request. The PII may be a hashed version of the PII.

In operation 544, the omni-channel management system 102 takes that hashed version of the PII and matches the PII to an identity profile in the identity profile store 208. The corresponding ODIN is then stored to the identified profile in operation 546. As such, the omni-channel management system 102 now has an ODIN that corresponds to that PII (e.g., e-mail address).

Subsequently in operation 548, a second publisher sends a request that contains the ODIN. The omni-channel management system 102 may not know who that user is, but the omni-channel management system 102 has the ODIN from the first publisher. As such, that ODIN becomes a bridge to identify the user in operation 550. Using the ODIN, the omni-channel management system 102, for example, may obtain the corresponding e-mail address for the second publisher.

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software, a program, an application, an applet, an app, or other executable code) for causing the machine 600 to perform any one or more of the methodologies discussed herein may be executed. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alpha-numeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks, POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A tangible machine-readable storage medium in communication with at least one processor, the machine-readable storage medium storing instructions which, when executed by the at least one processor of a machine, cause the machine to perform operations comprising:
obtaining identifiers from online and offline communication channels;
identifying a user that corresponds to at least one of the identifiers;
creating an identity profile for the user that contains the at least one of the identifiers corresponding to the user; and
maintaining the identity profile in an identity profile store of a management system.

2. The tangible machine-readable storage medium of claim 1, wherein the operations further comprise exchanging at least one known identifier in the identity profile with a carrier, the carrier to use a version of the known identifier in a communication directed to the management system.

3. The tangible machine-readable storage medium of claim 1, wherein the operations further comprise exchanging a known identifier with a publisher prior to receiving an ad request from the publisher, the publisher to use a version of the known identifier in the ad request.

4. The tangible machine-readable storage medium of claim 1, wherein the operations further comprise:
providing a first non-personally identifiable information to a third party, the third party to receive a second non-personally identifiable information from a publisher and to create a third party identifier that corresponds to the first and second non-personally identifiable information; and
receiving the third party identifier, the third party identifier to be stored in the identity profile.

5. The tangible machine-readable storage medium of claim 1, wherein the operations further comprise:
receiving a first publisher identifier and an ODIN from a first publisher;
matching and storing the ODIN to the identity profile;
receiving the ODIN from a second publisher; and
using the ODIN as an identity bridge.

6. The machine-readable storage medium of claim 1, wherein the operations further comprise:
receiving a communication containing an identifier; and
determining the identity profile that matches the identifier received in the communication.

7. The machine-readable storage medium of claim 6, wherein the determining comprises matching the identifier in the communication with the at least one of the identifiers in the identity profile.

8. The machine-readable storage medium of claim 6, wherein the operations further comprise:
accessing user profile information corresponding to the user of the identity profile; and
using the user profile information to determine an advertisement to return in response to the communication.

9. A method comprising:
obtaining identifiers from online and offline communication channels;
identifying a user that corresponds to at least one of the identifiers;
creating, using a processor of a machine, an identity profile for the user that contains the at least one of the identifiers corresponding to the user; and
maintaining the identity profile in an identity profile store of a management system.

10. The method of claim 9, further comprising exchanging at least one known identifier in the identity profile with a carrier, the carrier to use a version of the known identifier in a communication directed to the management system

11. The method of claim 9, further comprising exchanging a known identifier with a publisher prior to receiving an ad request from the publisher, the publisher to use a version of the known identifier in the ad request.

12. The method of claim 9, further comprising:
providing a first non-personal identifiable information to a third party, the third party to receive a second non-personal identifiable information from a publisher and to create a third party identifier that corresponds to the first and second non-personal identifiable information; and
receiving the third party identifier, the third party identifier to be stored in the identity profile.

13. The method of claim 9, further comprising:
receiving a first publisher identifier and an ODIN from a first publisher;
matching and storing the ODIN to the identity profile;
receiving the ODIN from a second publisher; and
using the ODIN as an identity bridge.

14. The method of claim 9, further comprising:
receiving a communication containing an identifier; and
determining the identity profile that matches the identifier received in the communication.

15. The method of claim 14, wherein the determining comprises matching the identifier in the communication with the at least one of the identifiers in the identity profile.

16. The method of claim 14, further comprising:
accessing user profile information corresponding to the user of the identity profile; and
using the user profile information to determine an advertisement to return in response to the communication.

17. A system comprising:
a processor of a machine; and
an omni-channel management system to
obtain identifiers from online and offline communication channels;
identify a user that corresponds to at least one of the identifiers;
create, using the processor of the machine, an identity profile for the user that contains the at least one of the identifiers corresponding to the user; and
maintain the identity profile in an identity profile store.

18. The system of claim 17, wherein the omni-channel management system is further to exchange matching identifiers with a carrier or a publisher prior to receiving an ad request from the carrier or the publisher.

19. The system of claim 17, wherein the omni-channel management system is further to:
provide a first non-personal identifiable information to a third party, the third party to receive a second non-personal identifiable information from a publisher and to create a third party identifier that corresponds to the first and second non-personal identifiable information; and
receive the third party identifier, the third party identifier to be stored in the identity profile.

20. The system of claim 17, wherein the omni-channel management system is further to:
receive a first publisher identifier and an ODIN from a first publisher;
match and store the ODIN to the identity profile;
receive the ODIN from a second publisher; and
use the ODIN as an identity bridge.
